(19) United States
(12) Patent Application Publication
(10) Pub. No.: US 2024/0039363 A1
(43) Pub. Date: Feb. 1, 2024

(54) TUBE-IN-TUBE STRUCTURE FOR LINEAR MOTOR MACHINE

(71) Applicant: AKRIBIS SYSTEMS PTE LTD, Singapore (SG)

(72) Inventors: Kok Kit CHEY, Singapore (SG); Yalei SUN, Singapore (SG); Shien Yang LEE, Singapore (SG); Wayne NG, Singapore (SG)

(21) Appl. No.: 18/022,672

(22) PCT Filed: Aug. 5, 2021
(86) PCT No.: PCT/SG2021/050459

§ 371 Date: Feb. 22, 2023

(30) Foreign Application Priority Data
Sep. 15, 2020 (SG) 10202009051X

(51) Int. Cl. H02K 5/24; H02K 41/02

(52) U.S. Cl. CPC H02K 5/24; H02K 41/02

(57) ABSTRACT

A tube-in-tube structure (100) for linear motor machine is disclosed. The tube-in-tube structure comprises (a) an outer metrology frame (20) for responding for responding to sustain a payload (50) and to allow moving of the payload (50) thereon; (b) an inner force frame (10) being enclosed within the hollow capacity (22) of the outer metrology frame (20) and responding to transfer any reaction force exerted by the payload (50) to the bottom of the inner force frame (10), wherein the bottom end of the inner force frame (10) is mounted to the bottom end of the outer metrology frame (20) and such mounting is located to the ground. The inner force frame (10) transfers any reaction force exerted by dynamic motion generated by the linear motor machine directly to the bottom of the inner force frame (10), thereby vibration due to the linear motor motion is thus minimized or settled.

### CROSS-REFERENCE TO RELATED APPLICATION

This application claims the benefit of Singapore Provisional Application No. 10202009051X, filed 15 Sep. 2020, entitled “A NOVEL TUBE-IN-TUBE STRUCTURE DESIGN FOR LINEAR MOTOR MACHINE.” The teachings of the foregoing application are hereby incorporated herein by reference.

### BACKGROUND OF THE INVENTION

### A. Field of The Invention

The present invention relates to frame structure, and more particularly to a tube-in-tube structure design for use in linear motor machine.

### B. Background Art

Machine tools, semiconductor and medical industries, etc all use linear motion machines to a significant extent. The performance of these linear machines relies on high speeds and very accurate positioning, and accordingly, the vibration due to linear motion machines must be settled in the course of application of the machines.

Generally speaking, a linear motor moving mechanism has both (i) metrology elements such as linear bearing, encoder scale, etc. and (ii) force element, such as motor core mounted on a common base. Newton's third law states that for every action (force) in nature there is an equal and opposite reaction.

When a motor is moving forward, the motor causes an equal reaction force to the common base structure. As a result of this reaction force, the common base structure will generate vibration. The base structure would deflect at opposite direction to the motor travelled direction. The motor would have to travel back and forth several times to be in a position. This means that the motion needs more time to settle down at a position. FIG. 2 (a) indicates a conventional structure being used as a common base structure for linear motor machines.

U.S. Pat. No. 5,105,109A discloses a support structure for a linear motor drive type of elevator consisting of a stator functioning as a secondary side of a linear motor and a moving element functioning as a primary side to said stator, the support structure being characterized in that one end of the stator is fastened to a building side through a first support means constituted as allowing vibration of the stator, and the other end of the stator is fastened to the building side through a secondary support means providing a pre-determined tension to the stator and absorbing vibration of the stator.

U.S. Pat. No. 6,098,969 A discloses a semi-active variable stiffness control (SAIVS) device, which can change its stiffness continuously and smoothly between a maximum and minimum stiffness. It comprises four spring and telescoping tube elements arranged in a rhombus configuration with pivot joints at the vertices. The SAIVS is installed as a connection between structural elements, and varies the connection stiffness smoothly by changing its configuration in response to a control algorithm in the computer.

### BRIEF SUMMARY OF THE INVENTION

These and other features, aspects and advantages of the present invention will become better understood with reference to the following drawings, description and claims.

A main object of the present invention is to provide a tube-in-tube structure (100) for linear motor machine comprising
(a) an outer metrology frame (20) having a pair of elongated metrology tube (20′) linked with a horizontal beam (24), wherein each of the elongated metrology tube (20′) has a top end and a bottom end, said outer metrology frame (20) having a hollow capacity (22) for responding to sustain a payload (50) and to allow moving of the payload (50) thereon;
(b) an inner force frame (10) having a plurality of inner force tubes (10′), wherein each of the inner force tube (10′) has a top end and a bottom end, and the inner force tubes (10′) are linked at the top end thereof with an inner horizontal beam (24′), said inner force frame (10) being enclosed within the hollow capacity (22) of the outer metrology frame (20) and responding to transfer any reaction force exerted by the payload (50) to the bottom of the inner force frame (10);
wherein the bottom end of the inner force tube (10′) is mounted to the bottom end of the outer metrology tube (20′), and the bottom of the inner force frame (10) equates to the bottom of the outer metrology frame (20), which equals to the location of the connection of the same to the ground.

Still an object of the present invention is to provide a tube-in-tube structure (100) for linear motor machine, further comprises a plurality of damping means (30) provided in between the inner force tube (10′) and the outer metrology tube (20′), said damping means (30) being spaced out between the inner force tube (10′) and the outer metrology tube (20′).

Yet another object of the present invention is to provide a tube-in-tube structure (100), wherein the damping means (30) are located within the hollow capacity (22) of the outer metrology tube (20′) in a way to cancel or to reduce vibration generated by the linear motor machine in motion.

Yet a further object of the present invention is to provide a tube-in-tube structure (100), wherein the vibration is the dynamic motion which is generated in the course of operation of the linear motor machine, and any reaction force generated by the linear motor machine is transferred by the inner force tube (10′) directly to the bottom of the inner force frame (10).

A further object of the present invention is to provide a tube-in-tube structure (100), wherein the outer metrology tube (20′) and the inner force tube (10′) are hollow and elongated, made from metal.

Yet a further object of the present invention is to provide a tube-in-tube structure (100) for linear motor machine, wherein the linear motor motion settling time is significantly reduced as any reaction force directly flowing from the force frame (10) is only a fraction of that flowing to the outer metrology frame (20).

Yet another object of the present invention is to provide a tube-in-tube structure (100) for linear motor machine, wherein the reaction force is transferred by the inner force frame directly to the bottom of the tube-in-tube structure.

A further object of the present invention is to provide a tube-in-tube structure (100) for linear motor machine, wherein the damping means is used to absorb energy from vibration so as to quickly settling down of motion.

### BRIEF DESCRIPTION OF THE SEVERAL VIEWS OF THE DRAWING

A fuller understanding of the nature and objects of the present invention will become apparent upon consideration of the following detailed description, taken in connection with the accompanying drawings, wherein:

FIG. 1 is a perspective view of the tube-in-tube structure for linear motion machine according to the invention;

FIG. 2 is a sectional view of a conventional tube structure for linear motion machine; and

FIG. 3 is a sectional view of the tube-in-tube structure for linear motion machine according to the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

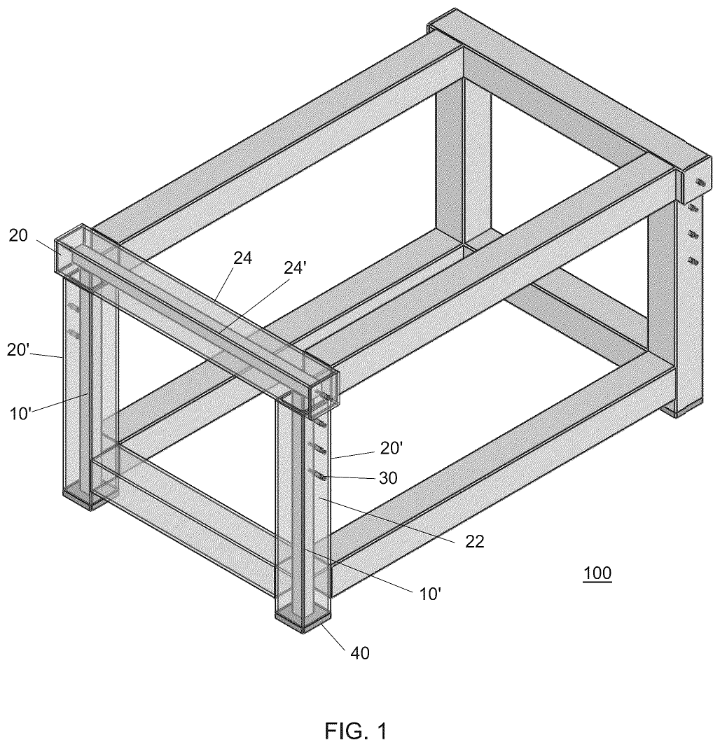

Referring to FIG. 1, broadly, there is shown a perspective view of the tube-in-tube structure for linear motion machine according to the invention. The tube-in-tube structure (100), which is a metal structure is for linear motor machine in a manufacturing process. The metal structure or the tube-in-tube structure (100) comprises (i) an outer structure member which is denoted as an outer metrology frame (20); (ii) an inner structure member which is denoted as an inner force frame (10); (iii) a plurality of damping means (30); and (iv) a bottom plate (40) which serves as the base for one end of the outer metrology frame (20) and the inner force frame (10). The outer metrology frame (20) has a pair of elongated metrology tube (20′) linked with an outer horizontal beam (24), wherein each of the elongated metrology tube (20.) has a top end and a bottom end, and the interior of the outer metrology frame (20) is a hollow cavity (22) and the outer horizontal beam (24) of the outer metrology frame (20) is for responding to sustain a payload (50) and to allow moving of the payload (50) thereon.

As shown in the figure of a preferred embodiment of the present invention, the inner force frame (10) has a pair of inner force tubes (10′), wherein each of the inner force tube (10′) has a top end and a bottom end, and the inner force tubes (10′) are linked at the top end thereof with an inner horizontal beam (24′), and the inner force tube (10′) is being enclosed within the hollow capacity (22) of the outer metrology tube (20′) and is responding to transfer any reaction force exerted by the payload (50) to the bottom of the inner force tube (10′).

In accordance with the preferred embodiment of the present invention, the plurality of damping means (30) is provided in between the inner force tube (10′) and the outer metrology tube (20′) within the hollow cavity (22), and the damping means (30) are substantially equally spaced out between the inner force tube (10′) and the outer metrology tube (20′). The bottom plate (40) is a flat base for the mounting of the bottom end of the inner force tube (10′) and the bottom end of the outer metrology tube (20′). The inner force frame (10) transfers any reaction force exerted by dynamic motion generated by the linear motor machine directly to the bottom of the inner force frame (10).

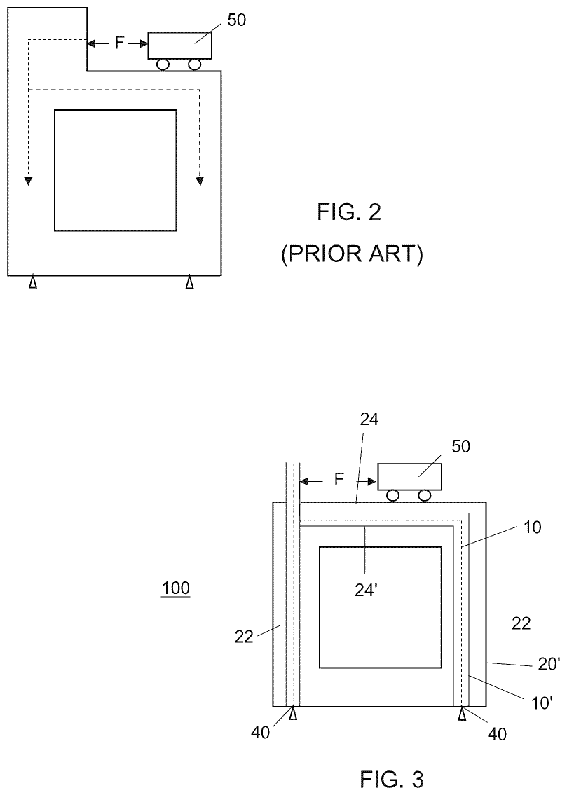

In general, a linear motor moving mechanism has a metrology element (such as linear bearing, encoder scale), and a force element (magnetic track) mounted on a common base. Based on Newton's Third Law of Motion, for every action (force) in nature, there is an equal and opposite reaction. As shown in FIG. 2, which depicts a sectional view of a conventional tube structure for linear motion machine, when a motor (50) is moving forward, the force exerted by the motor (50) causes an equal reaction force F to the common base structure. As a result of the reaction force, the common base structure will have vibration. The motor is required to travel back and forth several times so as to be in position. Thus, the vibration needs more time to settle down.

In general, as shown in FIG. 1, there is shown a tube-in-tube structure (100) for linear motor machine in accordance with the present invention, there will be 2 base/frames by utilizing different sizes of metal hollow beam or metal tube or the like. A smaller size tube element, which is the inner force frame (10) will be enclosed in a larger size tube element, which is the outer metrology frame (20). For this structure, the only common contact point is on the bottom plate (40) where both the bottom end of the tube elements (10′, 20′) are welded or mounted together. The metrology elements of a linear motor moving mechanism will be mounted on the outer metrology frame (20) while the force element is mounted on the inner force frame (10).

Referring to FIG. 3, there is shown a sectional view of the tube-in-tube structure (100) for linear motion machine according to the present invention. In this case, Newton's third law of motion is applicable. In the preferred embodiment of the present invention, the reaction force is transferred by the inner force frame (10) directly to the bottom plate (40) of the tube-in-tube structure (100). There is vibration which may occur on the inner force frame (10), but the vibration could be significantly mitigated from the outer metrology frame (20). Accordingly, the linear motor motion settling time of the linear motor machine can be significantly reduced as there is no reaction force which directly induces on the outer metrology frame (20).

The tube-in-tube structure (100) of the preferred embodiment is novel and unique as the structure (100) of the present invention is compact as compared to the conventional structure or similar structure in any of the prior art, where another or a second structure is needed which thus takes up more space and has more complex mechanical design and alignment. In the preferred embodiment, the inner force frame (10) is hidden inside the outer metrology frame (20), and the mechanical design is neat and the required alignment is much simpler.

In the present invention, the use of a plurality of damping means (30) is to improve the damping of the tube-in-tube structure (100) which enhances vibration settling. The damping means (30) can be any kind of damping devices, such as mechanical damper, shock absorber and any other material or liquid that could be filled into between the outer metrology frame (20) and the inner force frame (10). The plurality of damping means (30) are located within the hollow capacity (22) of the outer metrology frame (20) in a way to cancel or reduce vibration generated by the linear motor machine in motion, or in other words, the damping means (30) is used to absorb energy from vibration to achieve quick motion settling of the structure (100).

In the course of operation of the linear motor machine, any reaction force generated by the linear motor machine is transferred by the inner force frame (10) directly to the bottom of the inner force frame (10). The outer metrology frame (20) and the inner force frame (10) are elongated, hollow structure that made from metal.

Since certain changes may be made in the foregoing disclosure without departing from the scope of the invention herein involved, it is intended that all matter contained in the above description and depicted in the accompanying drawings be construed in an illustrative and not limiting sense.

1. A tube-in-tube structure for linear motor machine comprising
(a) an outer metrology frame having a pair of elongated metrology tube linked with a horizontal beam, wherein each of the elongated metrology tube has a top end and a bottom end, said outer metrology frame having a hollow capacity for responding to sustain a payload and to allow moving of the payload thereon; and
(b) an inner force frame having a plurality of inner force tubes, wherein each of the inner force tube has a top end and a bottom end, and the inner force tubes are linked at the top end thereof with an inner horizontal beam, said inner force frame being enclosed within the hollow capacity of the outer metrology frame and responding to transfer any reaction force exerted by the payload to the bottom of the inner force frame; wherein the bottom end of the inner force tube is mounted to the bottom end of the outer metrology tube and that such mounting of the bottom of the inner force frame and the bottom of outer metrology frame is located to the ground.

2. The tube-in-tube structure for linear motor machine as set forth in claim 1, further comprising a plurality of damping means being provided between the inner force tube and the outer metrology tube, said damping means being equally out between the inner force tube and the outer metrology tube.

3. The tube-in-tube structure for linear motor machine as set forth in claim 1, wherein the inner force tube is a smaller size tube element which is enclosed in the outer metrology tube which is larger size tube element.

4. The tube-in-tube structure for linear motor machine as set forth in claim 2, wherein the inner force tube is hidden in the outer metrology tube.

5. The tube-in-tube structure for linear motor machine as set forth in claim 4, wherein the common contact point of the bottom plate is formed by welding or mounting of the bottom ends of the inner force tube and the outer metrology tube.

6. The tube-in-tube structure for linear motor machine as set forth in claim 2, wherein the damping means are located within the hollow capacity of the outer metrology frame in a way to dissipate vibration energy generated by the linear motor machine in motion.

7. The tube-in-tube structure for linear motor machine as set forth in claim 6, wherein the damping means includes a viscous liquid, a particulate media, and a viscoelastic material.

8. The tube-in-tube structure for linear motor machine as set forth in claim 1, wherein the mounting of the bottom of the inner force frame to the bottom of outer metrology frame is located to the ground, and any reaction force generated by the linear motor machine is transferred by the inner force frame directly to the bottom of the inner force frame.

9. The tube-in-tube structure for linear motor machine as set forth in claim 1, wherein the outer metrology frame and the inner force frame are hollow beam made from metal.

10. The tube-in-tube structure for linear motor machine as set forth in claim 1, wherein the outer metrology frame is used to provide geometric guidance for the motion of a linear motor positioning system.

11. The tube-in-tube for linear motor machine as set forth in claim 2, wherein the plurality of damping means are operatively arranged such that energy due to vibration of the linear motor motion is absorbed to achieve rapid settle down motion.
